(19) United States
(12) Patent Application Publication
(10) Pub. No.: US 2007/0039871 A1
(43) Pub. Date: Feb. 22, 2007

(54) Inlet filter for high pressure spraying devices

(76) Inventors: Ghassem Zarbi, Abbotsford (CA); Rory Bjarnason, Abbotsford (CA)

Correspondence Address: Adam H. Jacobs, Suite 726, 1904 Farnam Street, Omaha, NE, 68102, US

(21) Appl. No.: 11/207,052

(22) Filed: Aug. 18, 2005

(51) Int. Cl. B01D 27/00

(52) U.S. Cl. 210/446; 210/459; 210/460; 239/289

(57) ABSTRACT

An inlet filter for high pressure spraying devices includes an inlet body having an inlet end and an outlet end, a hose coupling at the inlet end, an inlet fluid passage extending through the inlet body with at least one inlet body outflow port extending therethrough, at least one inlet body inflow port also extending through the inlet body interposed between the inlet body outflow port and the outlet end, an outlet body coupling on the outlet end, and an outlet fluid passage connecting the inlet body inflow port and the outlet end. An outlet body is releasably secured to the inlet body and further includes an outlet body fluid passage extending therethrough. A water filter is removably interposed between the inlet body outflow and inflow ports and a generally water-tight cover removably covers the water filter, the inlet body outflow port and the inlet body inflow port.

### BACKGROUND OF THE INVENTION

1. Technical Field

The present invention relates to filtration devices and, more particularly, to an inlet filter for a high pressure sprayer unit which includes an inlet body having an inlet fluid passage extending through the inlet body, at least one inlet body outflow port extending through a wall of the inlet body in fluid transmission connection with the inlet fluid passage, at least one inlet body inflow port extending through a wall of the inlet body interposed between the inlet body outflow port and the outlet end of the inlet body, an outlet body coupling with an outlet fluid passage extending within the inlet body connecting the inlet body inflow port and the outlet body coupling, an outlet body including an inlet end connectable to the outlet end of the inlet body which includes an outlet body fluid passage extending between and connecting the inlet end and outlet end of the outlet body, a filter removably interposed between the inlet body outflow port and the inlet body inflow port and a cover removably covering the filter, the inlet body outflow port and the inlet body inflow port to direct fluid flowing out of the inlet body outflow port through the filter into the inlet body inflow port.

2. Description of the Prior Art

Various devices such as dishwashers, car washes, high pressure washing devices, and other such cleaning devices are designed to intake a volume of water from a low pressure water source and through various means increase the pressure of the water and output the water in a high pressure and high velocity stream to use the high pressure water for cleaning purposes. One of the significant problems encountered in using low pressure water from a water supply, however, is that the water generally will include some amount of contaminants such as suspended particles of dirt, minerals, and other such particulates. The vast majority of high pressure washing devices use some type of pumping mechanism to increase the pressure of the water flowing into the device and force the water out of the directing spray nozzle and it is in this pumping device where particulate matter can potentially cause great damage. For example, as many pumps operate at speeds exceeding three thousand RPMs, small amounts of particulate matter entering the pump can cause significant grinding and wear and tear on the pumping mechanism which can shorten the operating life span of the pump and, in extreme circumstances, can result in a dangerous situation resulting from the breaking down of the pumping mechanism. For this reason, high pressure washing devices generally include some type of filtration device to initially filter the incoming low pressure water to prevent this type of damage from occurring.

Of the various types of cleaning devices discussed above, high pressure sprayers are some of the most widely used devices, and quite often these devices are used in situations where water quality is substandard, thus mandating the use of initial filtration devices. An important functional feature of such high pressure sprayers however, is that a regular flow of water must be maintained in order to permit proper functioning of the high pressure sprayer. Several different filtration devices have been proposed in the prior art, such as McKee, et al., U.S. Pat. No. 6,322,696, which attempts to address and solve the filtration problem encountered with high pressure spraying devices. The McKee device, however, does include at least one significant disadvantage, and that is that the inlet and outlet ports between which the filter is interposed are situated on separate pieces of the filter. This means that, unless the two pieces of the filter are properly secured to one another, the gap between the inlet and outlet ports may be different than as originally designed which can result in the filter not being seated correctly between the two ports. Furthermore, due to the vibrations and forces encountered by the filter, the two pieces of the filter can quite easily become loosened from one another again causing disruption in the operation of the filter. There is therefore a need for a filtration device which addresses and solves this deficiency found in the McKee device and, additionally, solves the deficiencies found in the prior art.

Therefore, an object of the present invention is to provide an improved inlet filter for a high pressure spraying device.

Another object of the present invention is to provide an improved inlet filter for high pressure spraying devices which includes an inlet body and an outlet body, the inlet body including both outflow ports and inflow ports on the inlet body to ensure that the spacing between the outflow ports and inflow ports remain unchanged regardless of whether the filter is properly assembled.

Another object of the present invention is to provide an improved inlet filter for high pressure spraying devices which includes a transparent cover over the filter to permit viewing of the filter during use of the inlet filter so that the operator can easily ascertain when the filter should be cleaned or replaced.

Another object of the present invention is to provide an inlet filter for high pressure spraying devices which will efficiently filter incoming water and may be used in connection with many different high pressure spraying devices.

Finally, an object of the present invention is to provide an improved inlet filter for high pressure spraying devices which is relatively simple and inexpensive in manufacture and construction and is safe, effective, and efficient in use.

### SUMMARY OF THE INVENTION

The present invention provides an inlet filter for high pressure spraying devices. The inlet filter includes an inlet body having an inlet end and an outlet end, the inlet body including a female hose coupling at the inlet end thereof, an inlet fluid passage extending through the inlet body in fluid transmission connection with the hose coupling, at least one inlet body outflow port extending through a wall of the inlet body in fluid transmission connection with the inlet fluid passage, the at least one inlet body outflow port operative to permit fluid flow therethrough, at least one inlet body inflow port extending through a wall of the inlet body interposed between the at least one inlet body outflow port and the outlet end of the inlet body, an outlet body coupling on the outlet end of the inlet body, and an outlet fluid passage extending within the inlet body and connecting the at least one inlet body inflow port and the outlet body coupling. An outlet body includes an inlet end having an inlet body coupling operative to cooperate with the outlet body coupling to releasably secure the outlet body to the inlet body and an outlet end, the outlet body further including an outlet body fluid passage extending between and connecting the inlet end and the outlet end of the outlet body. A water filter is removably interposed between the at least one inlet body outflow port and the at least one inlet body inflow port and a generally water-tight cover removably covers the water filter, the at least one inlet body outflow port and the at least one inlet body inflow port to direct fluid flowing out of the at least one inlet body outflow port passing through the water filter into the at least one inlet body inflow port.

The inlet filter for high pressure spraying devices as thus described provides a simple and efficient solution to the problems encountered in the use of high pressure spraying devices. For example, because the spacing distance between the outflow port and inflow port on the inlet body cannot change because the ports are positioned on the same element of the inlet filter, the precise reassembly of the inlet filter is not critical to proper functioning of the present invention because the filter will remain disposed between the outflow port and inflow port even if the inlet body and outlet body are not perfectly mated to one another. Also, the inclusion of multiple outflow ports and inflow ports in the walls of the inlet body ensure sufficient water flow through the inlet filter even if one of the ports becomes blocked or clogged by particulate debris. Finally, because the cover of the present invention is transparent, a user of the inlet filter may quickly and easily ascertain whether the filter needs to be cleaned or changed. The inlet filter of the present invention thus provides a substantial improvement over those devices found in the prior art.

### BRIEF DESCRIPTION OF THE DRAWINGS

FIG. 1 is a perspective view of the inlet filter for high pressure spraying devices of the present invention;

FIG. 2 is an exploded perspective view of the present invention showing the elements therein; and

FIG. 3 is a detailed side elevational view of the present invention showing the fluid passages therein.

### DESCRIPTION OF THE PREFERRED EMBODIMENT

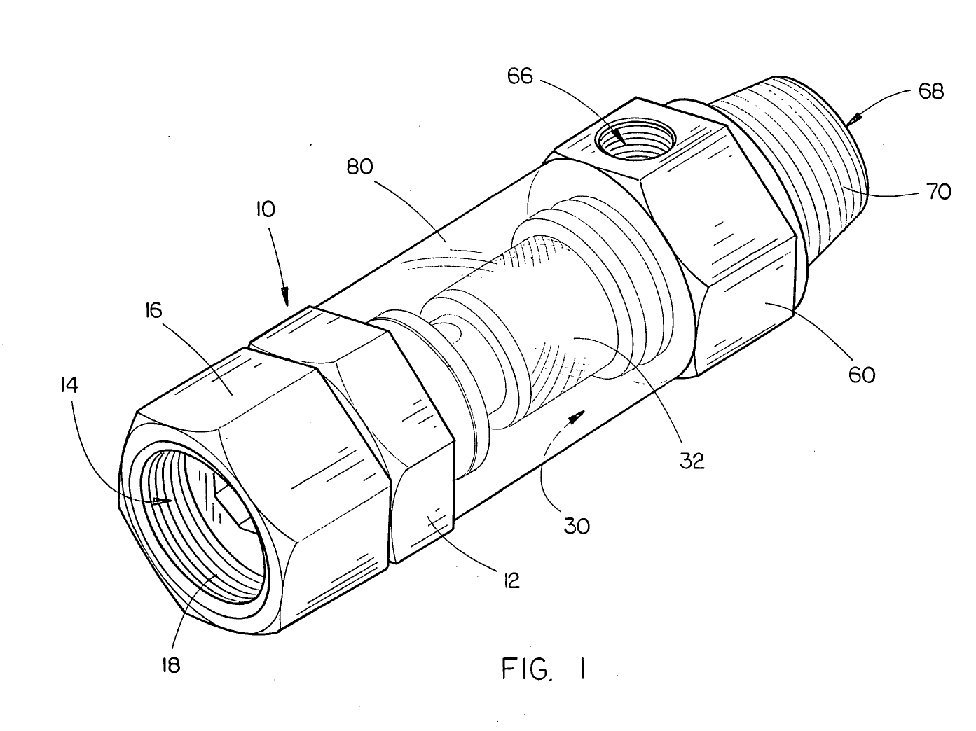

The inlet filter 10 of the present invention is shown best in FIGS. 1-3 as including two main elements, an inlet body 12 and an outlet body 60, the inlet body 12 and outlet body 60 removably connect to one another as will be described later in this disclosure. The inlet body 12 is preferably a generally cylindrical longitudinally elongated element constructed of metal which includes an inlet end 14 and an outlet end 44, the inlet end 14 further including a female coupling 16 which would be rotatably mounted on inlet end 14 of inlet body 12 and would include internal threads 18 adapted for connection to a hose or other such water transfer device. It is further preferred that the female coupling 16 be mounted on the inlet end 14 of inlet body 12 by a threaded mounting screw 20 having a central fluid passage 22 extending there through to permit water flow therethrough. Also, the female coupling 16 may be replaced with a male coupling should such substitution be desirable when used in connection with certain types of high pressure spraying devices.

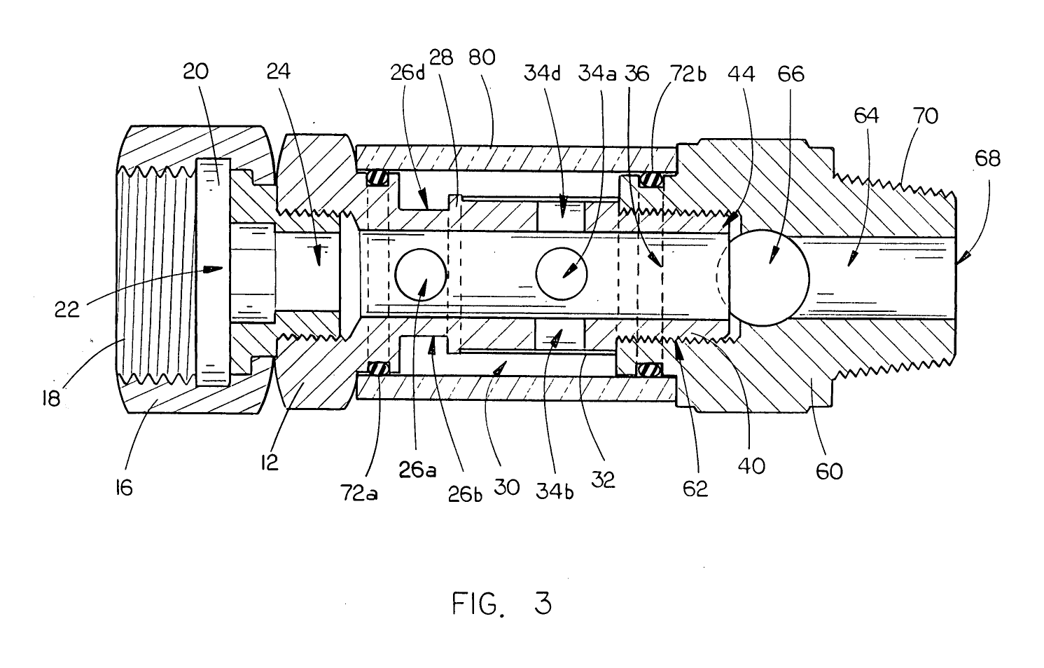

The main body of inlet body 12 would preferably include an inlet central fluid passage 24 which is in fluid transmission connection with the center fluid passage 22 of threaded mounting screw 20, as shown best in FIG. 3. At the inner end of inlet central fluid passage 24 would preferably be formed four inlet body outflow ports 26a, 26b, 26c, and 26d which extend through the side wall of inlet body 12 in fluid transmission connection with an external filtration chamber 30 as will be described later in this disclosure. In the preferred embodiment, each of the inlet body outflow ports 26a-d would be generally cylindrical in shape to provide for fluid transfer from the inlet central fluid passage 24 to the filtration chamber 30. To direct the incoming water out of the inlet central fluid passage 24 into the inlet body outflow ports 26a-d, an inlet body dividing wall 28 would be mounted within the inlet body 12 immediately after the inlet body outflow ports 26a-d, as shown in FIG. 3, which prevents fluid flow through the inlet body 12 excepting fluid flow out of the inlet body outflow ports 26a-d into the filtration chamber 30.

As the incoming water passes through the inlet body outflow ports 26a-d into the filtration chamber 30, it encounters filtration chamber cover 80 which, in the preferred embodiment, would be a generally cylindrical tube of transparent plastic material, as shown best in FIGS. 1-3. The incoming water passing through the inlet body outflow ports 26a-d thus swirls into the filtration chamber 30 and, due to the pressure of the water entering behind and the surrounding filtration chamber cover 80, is forced back into the inlet body 12 through four inlet body inflow ports 34a, 34b, 34c, and 34d which, in the preferred embodiment, are generally identical to the inlet body outflow ports 26a-d and would extend into the inlet body 12 to connect to outlet central fluid passage 36 which feeds the water towards the outlet end 44 of inlet body 12. Filtration of the inlet water is performed by the water passing through generally cylindrical water filter 32 which fits over the inlet body 12 covering the inlet body inflow ports 34a-d and abutting the inlet body dividing wall 28, as shown best in FIG. 3. In the preferred embodiment, water filter 32 would be constructed as a metal mesh screen which has very small pores or openings to remove the majority of particulate matter contaminating the inflow water. Of course, the precise nature of the water filter 32 may be modified or changed depending on the filtration desired with the inlet filter 10 of the present invention, and such modification would be understood by those skilled in the art of water filtration devices. One of the significant benefits of the inlet filter 10 of the present invention, however, is that the inclusion of four inlet body inflow ports 34a-d virtually ensures that water flow will continue even should one of the ports become clogged or should part of the filter become clogged by large amounts of particulate matter being screened thereby.

Also, it should be noted that the filtration chamber cover 80 is preferably operative only to contain the water exiting the inlet body outflow ports 26a-d, passing through the water filter 32 and flowing back into the four inlet body inflow ports 34a-d, and does not form a load-bearing structural element of the inlet filter 10. This permits the filtration chamber cover 80 to be substantially less thick as would be necessary were the filtration chamber cover 80 to be load-bearing, thus increasing the transparency of the filtration chamber cover 80 and facilitating viewing of the water filter 32 therethrough to determine whether the water filter 32 is clean enough to function properly.

Once the filtered water has passed into and through the inlet body inflow ports 34a-d into the outlet central fluid passage 36, the fluid must flow towards the outlet end 44 of the inlet body 12 due to the presence of inlet body dividing wall 28 interposed between the inlet body outflow ports 26a-d and inlet body inflow ports 34a-d. The outlet central fluid passage 36 extends into and through the outlet body coupling section 40 formed at the outlet end of 44 of inlet body 12, the outlet body coupling section 40 being a longitudinally extended threaded coupling section adapted to extend into and connect to the outlet body 60, as shown best in FIG. 3.

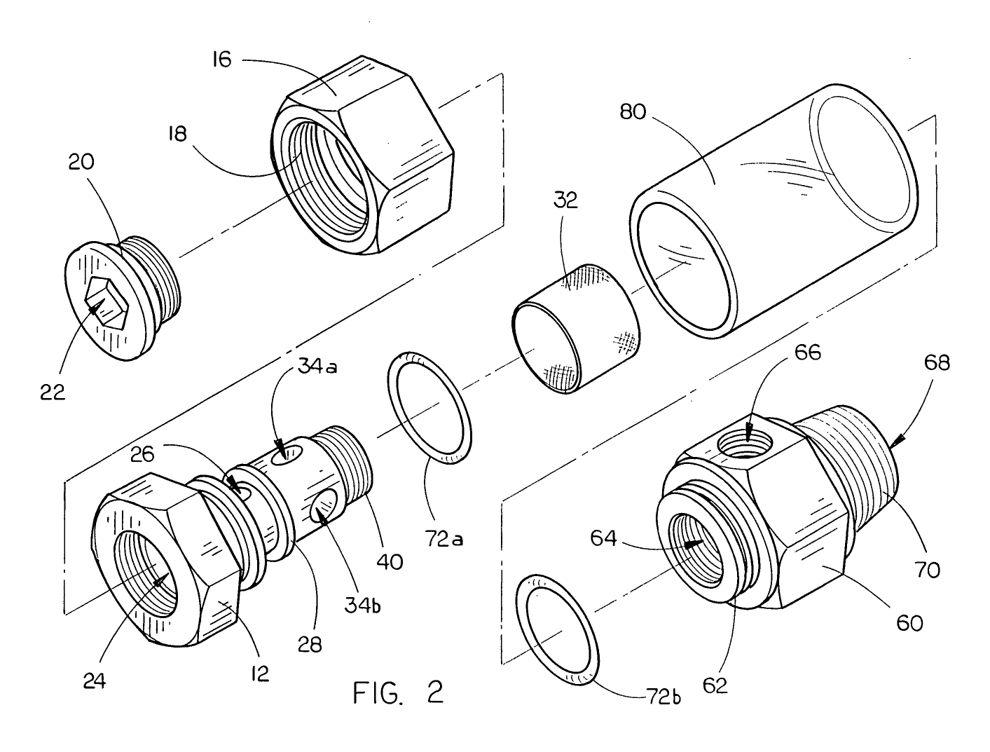

As shown best in FIG. 2, the outlet body 60 would preferably include an inlet end 62 and an outlet end 68 with an outlet body fluid passage 64 extending through the interior of outlet body 60. In this manner, water flowing through the outlet central fluid passage 36 of inlet body 12 flows through outlet body fluid passage 64 of outlet body 60 and out of the inlet filter 10 via the outlet end 68 of outlet body 60. Outlet body 60 may further include a vent opening 66 formed extending through the side wall of the outlet body 60 to permit mixing of air in with the incoming water should addition of air to the water be desirable for purposes of cleaning the high pressure spraying device or modifying the fluid output of the high pressure spraying device on which the inlet filter 10 is mounted. Of course, inclusion of the vent passage 66 is not critical to the present invention, but is preferable in order to permit proper adjustment of the air/water mixture into the high pressure spraying device. Finally, the outlet end 68 of outlet body 60 would preferably include external threads 70 adapted for connection to a female coupling mounted on the high pressure spraying device, although the exact nature of the connection between the inlet filter 10 and high pressure spraying device will be determined on a case-by-case basis depending on the type of high pressure spraying device being used in connection with the inlet filter 10 of the present invention.

The inlet filter 10 of the present invention would preferably also include a pair of filtration chamber cover O-rings 72a and 72b which would be mounted on the inlet body 12 and outlet body 60, respectively, as shown in FIGS. 2 and 3. The O-rings would create a fluid-tight seal between the filtration chamber cover 80 and inlet body 12 and outlet body 60 when the inlet body 12 and outlet body 60 are mated to one another via the outlet body coupling section 40, as was described previously. This would act to ensure the integrity of the filtration chamber 30 and thus prevent unintentional water release from the inlet filter 10 when the filter is in operation. Of course, other types of fluid-tight sealing devices are known in the prior art and the use of such sealing devices should be understood to be a part of this disclosure.

The inlet filter 10 of the present invention would function in the following manner. Once a water source is connected to the female coupling 16 of inlet filter 10, water will flow into the female coupling 16, through the center fluid passage 22 of threaded mounting screw 20 and into the inlet central fluid passage 24 of inlet body 12. As the water flows through the inlet body 12, it encounters inlet body dividing wall 28 and is directed outwards through inlet body outflow ports 26a-d formed in inlet body 12. This forces the incoming water into the filtration chamber 30 where it is subsequently forced through water filter 32 into the inlet body inflow ports 34a-d also mounted on inlet body 12, as described previously. The filtered water then passes through the inlet body inflow ports 34a-d into the outlet central fluid passage 36 outwards to the outlet end 44 of inlet body 12. The filtered water then passes into outlet body 60 through outlet body fluid passage 64 where it may be mixed with some degree of air via vent passage 66 and the water then exits the inlet filter 10 via outlet end 68 of outlet body 60 to flow into the high pressure spraying device on which the inlet filter 10 is mounted.

The significant advantages of the inlet filter 10 of the present invention are thus shown, in that the placement of the inlet body outflow ports 26a-d and inlet body inflow ports 34a-d on the inlet body 12 alone ensure that the spacing between the two sets of ports remains constant regardless of whether the inlet body 12 and outlet body 60 are properly connected to one another. In addition to the benefit of improving operational efficiency of the filter, this also means that, should the inlet body outflow ports 26a-d or inlet body inflow ports 34a-d become clogged, it is necessary only to replace the inlet body 12 section of the inlet filter 10 instead of making a determination of whether it is the inlet body 12 or outlet body 60 which includes the clogged port. This makes operation, cleaning, and replacement of the components of the inlet filter 10 of the present invention far easier than encountered in connection with those filtration devices found in the prior art.

It is to be understood that numerous additions, modifications, and substitutions may be made to the inlet filter 10 of the present invention which fall within the intended broad scope of the appended claims. For example, the precise number of inlet body outflow ports 26a-d and inlet body inflow ports 34a-d may be modified or changed so long as the two sets of ports are both located on the inlet body 12. Furthermore, the precise nature and design of the water filter 32 may be modified or changed depending on the degree of filtration desired in connection with the inlet filter 10, as it may be necessary to utilize a water filter having larger pore openings to permit sufficient water flow through the inlet filter 10 when the inlet filter 10 is used in connection with large-volume high pressure spraying devices. Also, although the filtration chamber cover 70 has been described as being transparent, it may be sufficient to make only a portion of the filtration chamber cover 70 transparent with the remainder being opaque to still permit viewing of the water filter 32 therethrough should such a design change be desirable. Finally, it should be noted that modifications to the size, shape, and construction materials used in connection with the present invention are contemplated so long as the functional characteristics of the inlet filter 10 of the present invention are neither degraded nor destroyed.

There has therefore been shown and described an inlet filter 10 for high pressure spraying devices which accomplishes at least all of its intended objectives.

I claim:

1. An inlet filter for high pressure spraying devices comprising:
an inlet body having an inlet end and an outlet end, said inlet body including;
coupling means at said inlet end thereof,
an inlet fluid passage extending through said inlet body in fluid transmission connection with said inlet end,
at least one inlet body outflow port extending through a wall of said inlet body in fluid transmission connection with is said inlet fluid passage, said at least one inlet body outflow port operative to permit fluid flow therethrough,
at least one inlet body inflow port extending through a wall of said inlet body interposed between said at least one inlet body outflow port and said outlet end of said inlet body,
outlet body coupling means on said outlet end of said inlet body, and
an outlet fluid passage extending within said inlet body and connecting said at least one inlet body inflow port and said outlet body coupling means;
an outlet body including an inlet end having inlet body coupling means operative to cooperate with said outlet body coupling means to releasably secure said outlet body to said inlet body and an outlet end, said outlet body further including an outlet body fluid passage extending between and connecting said inlet end and said outlet end of said outlet body;
filter means removably interposed between said at least one inlet body outflow port and said at least one inlet body inflow port; and
cover means removably covering said filter means, said at least one inlet body outflow port and said at least one inlet body inflow port to direct fluid flowing out of said at least one inlet body outflow port through said filter means into said at least one inlet body inflow port.

2. The inlet filter of claim 1 further comprising a fluid-impervious inlet body dividing wall formed in said inlet body adjacent said at least one inlet body outflow port intermediate said at least one inlet body outflow port and said outlet end of said inlet body, said inlet body dividing wall operative to divert fluid flowing through said inlet fluid passage out of said inlet body through said at least one inlet body outflow port.

3. The inlet filter of claim 1 wherein said filter means comprises generally cylindrical water filter adapted to fit over a portion of said inlet body and cover said at least one inlet body inflow port, said water filter being constructed of a metal mesh screen having pores extending therethrough operative to screen and remove particulate matter contaminating the inflow water while permitting water flow therethrough.

4. The inlet filter of claim 1 comprising four inlet body outflow ports extending through a side wall of said inlet body.

5. The inlet filter of claim 1 comprising four inlet body inflow ports extending through a side wall of said inlet body.

6. The inlet filter of claim 1 wherein said cover means is generally transparent to permit viewing of said filter means housed therewithin.

7. The inlet filter of claim 1 wherein said cover means is generally non-load-bearing.

8. An inlet filter for high pressure spraying devices comprising:
an inlet body having an inlet end and an outlet end, said inlet body including;
coupling means at said inlet end thereof,
an inlet fluid passage extending through said inlet body in fluid transmission connection with said inlet end,
at least one inlet body outflow port extending through a wall of said inlet body in fluid transmission connection with said inlet fluid passage, said at least one inlet body outflow port operative to permit fluid flow therethrough,
a fluid-impervious inlet body dividing wall formed in said inlet body adjacent said at least one inlet body outflow port intermediate said at least one inlet body outflow port and said outlet end of said inlet body, said inlet body dividing wall operative to divert fluid flowing through said inlet fluid passage out of said inlet body through said at least one inlet body outflow port,
at least one inlet body inflow port extending through a wall of said inlet body interposed between said inlet body dividing wall and said outlet end of said inlet body,
outlet body coupling means on said outlet end of said inlet body, and
an outlet fluid passage extending within said inlet body and connecting said at least one inlet body inflow port and said outlet body coupling means;
an outlet body including an inlet end having inlet body coupling means operative to cooperate with said outlet body coupling means to releasably secure said outlet body to said inlet body and an outlet end, said outlet body further including an outlet body fluid passage extending between and connecting said inlet end and said outlet end of said outlet body;
filter means removably interposed between said at least one inlet body outflow port and said at least one inlet body inflow port; and
generally transparent cover means removably covering said filter means, said at least one inlet body outflow port, said inlet body dividing wall and said at least one inlet body inflow port to direct fluid flowing out of said at least one inlet body outflow port through said filter means into said at least one inlet body inflow port.

9. The inlet filter of claim 8 wherein said filter means comprises generally cylindrical water filter adapted to fit over a portion of said inlet body and cover said at least one inlet body inflow port, said water filter being constructed of a metal mesh screen having pores extending therethrough operative to screen and remove particulate matter contaminating the inflow water while permitting water flow therethrough.

10. The inlet filter of claim 8 comprising four inlet body outflow ports extending through a side wall of said inlet body.

11. The inlet filter of claim 8 comprising four inlet body inflow ports extending through a side wall of said inlet body.

12. The inlet filter of claim 8 wherein said cover means is generally non-load-bearing.

13. An inlet filter for high pressure spraying devices comprising:
an inlet body having an inlet end and an outlet end, said inlet body including;
an inlet fluid passage extending through said inlet body in fluid transmission connection with said inlet end,
at least one inlet body outflow port extending through a wall of said inlet body in fluid transmission connection with said inlet fluid passage,
a fluid-impervious inlet body dividing wall formed in said inlet body adjacent said at least one inlet body outflow port intermediate said at least one inlet body outflow port and said outlet end of said inlet body, said inlet body dividing wall operative to divert fluid flowing through said inlet fluid passage out of said inlet body through said at least one inlet body outflow port,
at least one inlet body inflow port extending through a wall of said inlet body interposed between said inlet body dividing wall and said outlet end of said inlet body,
outlet body coupling means on said outlet end of said inlet body, and
an outlet fluid passage extending within said inlet body and connecting said at least one inlet body inflow port and said outlet body coupling means;
an outlet body including an inlet end having inlet body coupling means operative to cooperate with said outlet body coupling means to releasably secure said outlet body to said inlet body and an outlet end, said outlet body further including an outlet body fluid passage extending between and connecting said inlet end and said outlet end of said outlet body;
a generally cylindrical filter removably interposed between said at least one inlet body outflow port and said at least one inlet body inflow port and adapted to fit over a portion of said inlet body covering said at least one inlet body inflow ports, said filter abutting said inlet body dividing wall; and
cover means removably covering said filter means, said at least one inlet body outflow port, said inlet body dividing wall and said at least one inlet body inflow port to direct fluid flowing out of said at least one inlet body outflow port through said filter means into said at least one inlet body inflow port.
